(19) United States
(12) Patent Application Publication
(10) Pub. No.: US 2022/0167052 A1
(43) Pub. Date: May 26, 2022

(54) DYNAMIC, USER-SPECIFIC CONTENT ADAPTATION

(71) Applicant: AT&T Intellectual Property I, L.P., Atlanta, GA (US)

(72) Inventors: Barkha Pathik Patel, Austin, TX (US); Michael J. Gonzales, Austin, TX (US); Taylor Gift, Austin, TX (US); James H. Pratt, Round Rock, TX (US); Eric Zavesky, Austin, TX (US)

(21) Appl. No.: 17/100,814

(22) Filed: Nov. 20, 2020

(51) Int. Cl. H04N 21/466; H04N 21/45

(52) U.S. Cl. CPC H04N 21/4661; H04N 21/4532; H04N 21/4524

(57) ABSTRACT

An example method includes detecting an audience for a first item of media content being delivered to a user endpoint device, wherein the audience includes at least a first user, monitoring a reaction of the first user to the first item of media content during a presentation of the first item of media content on the user endpoint device, determining an adaptation to be made to the presentation of the first item of media content in response to the reaction of the first user, and sending an instruction to at least one device to make the adaptation to the presentation in response to the reaction of the first user.

The present disclosure relates generally to media distribution, and relates more particularly to devices, non-transitory computer-readable media, and methods for dynamically adapting media content to specific users in real time.

### BACKGROUND

Consumers (e.g., users of media content, hereinafter also referred to as simply “users”) are being presented with an ever increasing number of services via which media content can be accessed and enjoyed. For instance, streaming video and audio services, video on demand services, social media, and the like are offering more forms of content (e.g., short-form, always-on, raw sensor feed, etc.) and a greater number of distribution channels (e.g., mobile channels, social media channels, streaming channels, just-in-time on-demand channels, etc.) than have ever been available in the past. As the number of choices available to users increases and diversifies, service providers seeking to retain their customer bases are looking for ways to increase the engagement of their customers with their content.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for dynamically adapting media content to specific users in real time may operate;

FIG. 2 illustrates a flowchart of an example method for dynamically adapting media content to specific users in real time, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for dynamically adapting media content to specific users in real time. In one example, a method performed by a processing system includes detecting an audience for a first item of media content being delivered to a user endpoint device, wherein the audience includes at least a first user, monitoring a reaction of the first user to the first item of media content during a presentation of the first item of media content on the user endpoint device, determining an adaptation to be made to the presentation of the first item of media content in response to the reaction of the first user, and sending an instruction to at least one device to make the adaptation to the presentation in response to the reaction of the first user.

In another example, a non-transitory computer-readable medium may store instructions which, when executed by a processing system in a communications network, cause the processing system to perform operations. The operations may include detecting an audience for a first item of media content being delivered to a user endpoint device, wherein the audience includes at least a first user, monitoring a reaction of the first user to the first item of media content during a presentation of the first item of media content on the user endpoint device, determining an adaptation to be made to the presentation of the first item of media content in response to the reaction of the first user, and sending an instruction to at least one device to make the adaptation to the presentation in response to the reaction of the first user.

In another example, a device may include a processing system including at least one processor and non-transitory computer-readable medium storing instructions which, when executed by the processing system when deployed in a communications network, cause the processing system to perform operations. The operations may include detecting an audience for a first item of media content being delivered to a user endpoint device, wherein the audience includes at least a first user, monitoring a reaction of the first user to the first item of media content during a presentation of the first item of media content on the user endpoint device, determining an adaptation to be made to the presentation of the first item of media content in response to the reaction of the first user, and sending an instruction to at least one device to make the adaptation to the presentation in response to the reaction of the first user.

As discussed above, as the number of services via which users may access media content increases and diversifies, service providers seeking to retain their customer bases are looking for ways to increase the engagement of their customers with their content. Some approaches attempt to maximize a user's engagement with content by tailoring the content based on a priori knowledge of the user's interests or preferences, or the interests or preferences of a demographic group including the user (e.g., teenagers, residents of a city that is home to a particular football team, gamers, etc.). For instance, the user may be shown advertisements for products related to the user's recent Internet searches, or television shows may be recommended to the user based on other television shows that the user has recently watched. The content meant to increase user engagement is typically predetermined and codified as static content (e.g., a laugh track that is played at a specific time, or predefined choices for a choose-your-own-adventure-style media).

A user's engagement with an item of content may not remain constant over the duration of the item of content, however, even when that item of content is specifically tailored to the user's interests or preferences. For instance, some portions of the item of content may engage the user more than other portions, due to the user's mood (e.g., happy, sad, scared, hungry, etc.), the presence of distractions (e.g., phone calls, pets or children, other people with whom the user is experiencing the content, etc.), changes in the tone of the content (e.g., a funny scene suddenly followed by gratuitous violence), and/or other factors. Moreover, when multiple users are experiencing the same item of content together (e.g., a family watching a movie together, a group of friends playing a virtual reality game together, etc.), different users may experience different levels of engagement with the same portion of the content. For instance, one user may cover his eyes during a gory scene, while another user may be on the edge of her seat, or one user may cover her ears when a particular song is played, while another user may sing enthusiastically along with the song.

Examples of the present disclosure may continuously monitor a user's reactions to an item of content that is being presented to the user, such as a television show, a movie, a video game, an immersive or volumetric video, an augmented reality media, or the like. In response to changes in the user's reactions, the presentation of the content may be dynamically adapted to improve the user's engagement with the content. For instance, if the user reacts to a gory scene of a movie by covering his eyes, the remainder of the scene may be skipped (or the playback speed of the remainder of the scene may be increased). Alternatively, if the user laughs out loud at a funny scene, an extended version of the scene may be presented to the user. In some examples, the content may be augmented with external content that is personalized for the user. For instance, a canned laugh track may be replaced with the sound of the user's friend or family member laughing.

In some examples, where multiple users are experiencing the presentation of the item of content together, the multiple users may react in different ways to the same portion of the content (e.g., the same scene of a movie). For instance, a first user may cover his eyes in response to a gory scene, while a second user may flinch, and a third user may show no discomfort at all. In this case, the presentation of the item of content may be dynamically adjusted in a manner that mediates among the different, possibly conflicting reactions. In one example, mediating among different reactions may involve making the most conservative possible adjustment (e.g., skipping a remainder of the gory scene), adjusting to a middle ground between the most extreme reactions (e.g., cutting the gory scene short), letting the users select one among them whose reactions will control the adjustments (e.g., “adjust to John's reactions”), or other forms of mediation.

In further examples, the content may be presented, and the users' reactions may be monitored, using a personal playback device such as a head mounted display (HMD). This may allow multiple users to simultaneously experience the same content, but presented in different ways that are respectively personalized for the multiple users. For instance, three users may be watching the same movie on respective HMDs. However, during a funny scene, a first user may be presented with an extended version of the scene on his HMD in response to the first user laughing out loud. For a second user who smiled at the scene, her HMD may play the sound of the second user's friend laughing during the scene. For a third user who did not seem to find the scene funny, his HMD may skip the scene or cut the scene short.

Although examples of the present disclosure are discussed within the context of visual media, it will be appreciated that the examples described herein could apply equally to non-visual media, or to media that does not have a visual component. For instance, examples of the present disclosure could be used to dynamically adapt a podcast, a streaming radio station, an audio book, or the like.

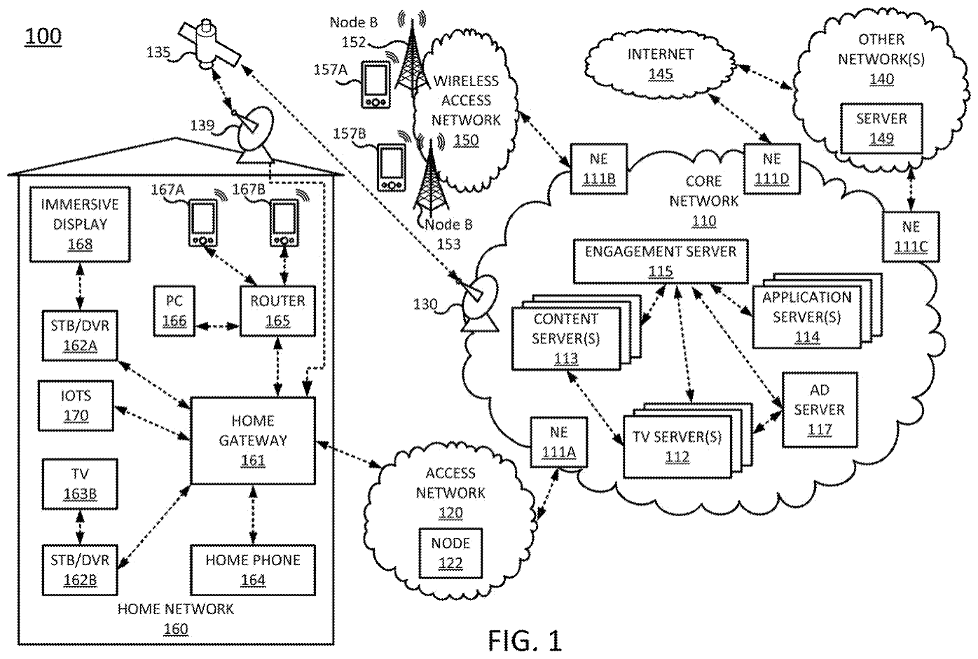

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth, with one another and with various other devices via a core network 110, a wireless access network 150 (e.g., a cellular network), an access network 120, other networks 140 and/or the Internet 145. In some examples, not all of the mobile devices and home network devices will be utilized in the adaptation of media content. For instance, in some examples, presentation of adaptive media may make use of the home network devices (e.g., immersive display 168, STB/DVR 162A, and/or Internet of Things devices (IoTs) 170), and may potentially also make use of any co-located mobile devices (e.g., mobile devices 167A and 167B), but may not make use of any mobile devices that are not co-located with the home network devices (e.g., mobile devices 157A and 157B).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an engagement server 115 (e.g., an application server). For ease of illustration, various additional elements of core network 110 are omitted from FIG. 1.

In one example, engagement server 115 may monitor a user's reactions to an item of media content, which may be delivered to a device in the home network 160 (e.g., one or more of the mobile devices 157A, 157B, 167A, and 167B, the PC 166, the home phone 164, the TV 163, the immersive display 168, and/or the Internet of Things devices (loTs) 170) by the TV servers 112, the content servers 113, the application servers 114, and/or the ad server 117. For instance, the engagement server 115 may receive data related to the user's reactions directly from the device to which the item of media content is delivered (e.g., the device presenting the item of media content to the user). The data may include, e.g., sensor readings from one or more sensors of the device to which the item of media content is delivered (e.g., cameras, microphones, biometric sensors, etc.). The data may also include direct user feedback received by the device (e.g., a request to skip a portion of the item of media content, a request to replay a portion of the item of media content, a request to pause playback of the item of media content, etc.). The data may be received by the engagement server 115 in real time, e.g., as the sensors collect the data. The engagement server 115 may alternatively or in addition receive the data from other devices in the vicinity of the device to which the item of media content is being delivered. For instance, the data could be collected by one or more IoT devices (e.g., a virtual assistant device, a security system, etc.), by the user's mobile phone or wearable smart device (e.g., smart watch or fitness tracker), or the like.

The engagement server 115 may analyze the data in real time (e.g., as the data is received) in order to estimate the user's current engagement with the item of media content. For instance, as discussed above, the user's engagement with the item of media content may vary over time. The engagement server 115 may estimate the user's current engagement with the item of media content in a variety of ways. For instance, the engagement server 115 could perform image processing on camera images of the user (e.g., facial analysis of images of the user's face, or image analysis of the user's body language, could indicate a likely current reaction of the user to the item of media content). Alternatively, the engagement server 115 could perform content analysis on an audio signal of the user (e.g., the user's current reaction could be indicated by laughing, screaming, crying, etc.; sentiment analysis may be performed on utterances made by the user, such as exclamations of surprise or disappointment; or if the user is carrying on a conversation with another person, this may indicate that the user is not paying attention to the presentation of the item of media content or is not engaged). In further examples, the engagement server 115 may perform analysis of biometric indicators of the user in order to estimate the user's current reaction (e.g., increased heart rate, increased skin conductivity, dilated pupils, and/or other indicators may indicate that the user is scared, while a lowered heart rate, steady breathing, and/or other indicators may indicate that the user is calm or bored).

In response to the user's reaction to the item of media content, the engagement server 115 may generate and transmit an adaptation to be made to the presentation of the item of media content in real time to improve the user's engagement with the item of media content. The adaptation may involve skipping a portion of the item of media content (e.g., by deleting or increasing playback speed of the portion), adding a portion to the item of media content (e.g., transmitting an extended version of a scene, director's commentary, etc.), or transmitting external content (e.g., content that is not part of the stream of data containing the item of media content) to augment the user's experience of the item of media content. For instance, if the data collected by the sensors indicates that the user is scared (e.g., images of the user depict him with his hands over his eyes, audio of the user shows him screaming, biometric sensors indicate an elevated heart rate, etc.), then the engagement server 115 may generate an adaptation that seeks to make the user less scared. For instance, the engagement server 115 may send an instruction to the device on which the item of media content is being presented instructing the device to skip playback ahead to a specific frame or time stamp of the item of media content that occurs after the current scene. Alternatively, if the data indicates that the user is amused (e.g., images of the user depict him smiling, audio of the user shows him laughing, etc.), then the engagement server 115 may send an extended version of the current scene to the device on which the item of media content is being presented, or may send a separate stream of data containing audio of the user's friend laughing.

In one example the engagement server 115 may additionally have access to user profiles that store information related to user preferences and viewing history. The user profiles may be retrieved from network storage, e.g., application servers 114, by the engagement server 115. For instance the user profiles may be maintained by a network service (e.g., an Internet service provider, a streaming media service, a gaming subscription, etc.). In a further example, the user profiles may include portions of social media profiles maintained by a social media web site (e.g., a social networking site, a blogging site, a photo-sharing site, etc.). The user profiles may indicate information about the users, such as the users' backgrounds (e.g., alma mater, home town, etc.), interests (e.g., favorite sports teams, hobbies, etc.), profession, viewing history (previously viewed media content that the users did or did not like, previous adaptations made to improve engagement of the users and whether or not the adaptations were successful), and the like. In further examples, the user profiles may store unique, user-specific media or other information that may be used to improve the engagement of the users. For instance, a user profile for a particular user may include an audio file of the particular user's friend or family member laughing, and the audio file may be playable when the particular user is presented with an item of media content. Furthermore, a user profile may indicate that the user is fond of scary movies and like the experience of being scared such that the engagement server 115 may actually increase the level of scariness of a media content even though there is a clear indication from the user's reaction that he is already scared. In other words, the engagement server 115 may take into account of the user profile preferences in its dynamic adaptation routine responsive to the user's reactions to a media content.

The engagement server 115 may also have access to third party data sources (e.g., server 149 in other network 140), where the third party data sources may comprise historical, background and other data relating to people, places, and things that may be depicted in items of media content.

The engagement server 115 may interact with television servers 112, content servers 113, and/or advertising server 117, to select which video programs (or other content), advertisements, and/or enhancements to include in media content being delivered to a user endpoint device. For instance, the content servers 113 may store scheduled television broadcast content for a number of television channels, video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to subscribers, e.g., in the home network 160 and at other downstream viewing locations. For example, advertisers may upload various advertising content to the core network 110 to be distributed to various viewers.

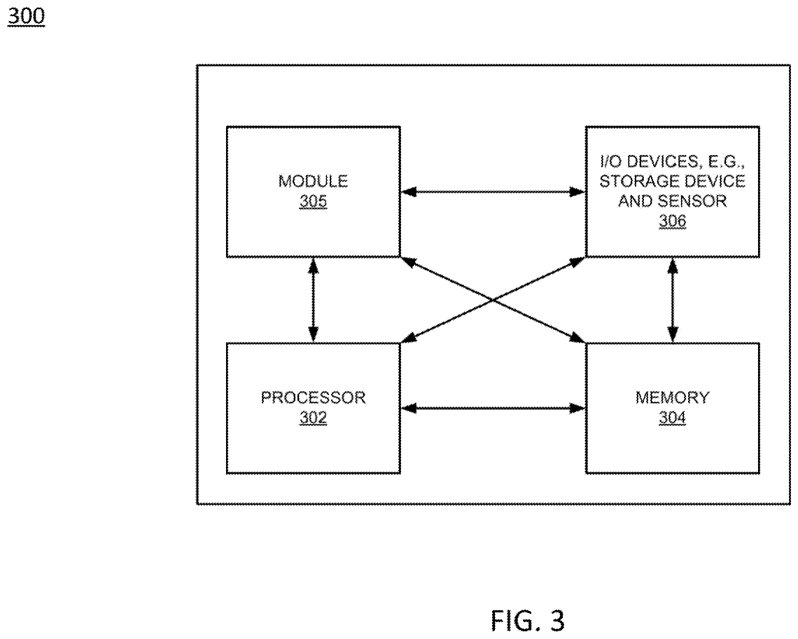

In one example, any or all of the television servers 112, content servers 113, application servers 114, engagement server 115, and advertising server 117 may comprise a computing system, such as computing system 300 depicted in FIG. 3.

In one example, the access network 120 may comprise a Digital Subscriber Line (DSL) network, a broadband cable access network, a Local Area Network (LAN), a cellular or wireless access network, a 3rd party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163 and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, loTs 170 and so forth.

In one example, router 165 may further communicate with TV (broadly a display) 163 and/or immersive display 168, e.g., where one or both of the television and the immersive display incorporates “smart” features. The immersive display may comprise a display with a wide field of view (e.g., in one example, at least ninety to one hundred degrees). For instance, head mounted displays, simulators, visualization systems, cave automatic virtual environment (CAVE) systems, stereoscopic three dimensional displays, and the like are all examples of immersive displays that may be used in conjunction with examples of the present disclosure. In other examples, an “immersive display” may also be realized as an augmentation of existing vision augmenting devices, such as glasses, monocles, contact lenses, or devices that deliver visual content directly to a user's retina (e.g., via mini-lasers or optically diffracted light). In further examples, an “immersive display” may include visual patterns projected on surfaces such as windows, doors, floors, or ceilings made of transparent materials.

In another example, the router 165 may further communicate with one or more loTs 170, e.g., a connected security system, an automated assistant device or interface, a connected thermostat, a connected speaker system, or the like. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163 and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

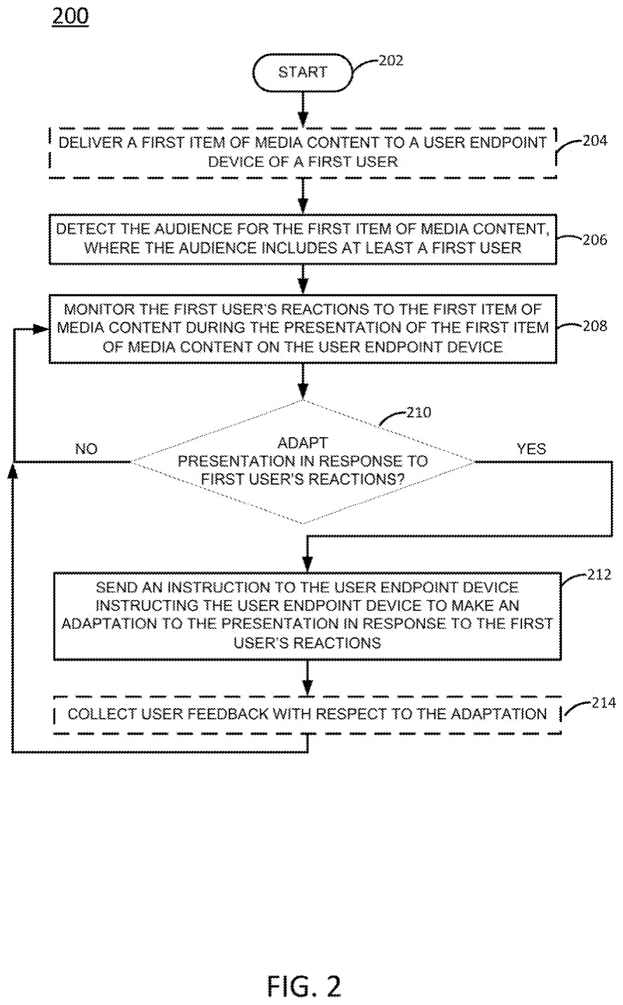

FIG. 2 illustrates a flowchart of an example method 200 for dynamically adapting media content to a specific user (e.g., a “first user”) in real time, in accordance with the present disclosure. In one example, steps, functions and/or operations of the method 200 may be performed by a device as illustrated in FIG. 1, e.g., engagement server 115 or any one or more components thereof. In one example, the steps, functions, or operations of method 200 may be performed by a computing device or system 300, and/or a processing system 302 as described in connection with FIG. 3 below. For instance, the computing device 300 may represent at least a portion of the engagement server 115 in accordance with the present disclosure. For illustrative purposes, the method 200 is described in greater detail below in connection with an example performed by a processing system, such as processing system 302.

In one example, prior to execution of the method 200, it is assumed that the processing system may have performed some prior analysis of one or more items of media content. For instance, the processing system may analyze an item of media content to determine a genre (e.g., comedy, action, kids) of the item of media content, a type (e.g., film, television show, video game) of the item of media content, objects (e.g., people, places, things) that may be depicted in various scenes of the item of media content, and/or other information. This may help the processing system to distill the items of media content to specific timed events (associated, e.g., with specific timestamps, scene breaks, or the like). For instance, the processing system may be able to determine that a movie includes a scene of graphic violence that begins at a first timestamp and ends at a second timestamp.

Alternatively, the processing system may have access to a data store in which this information has already been determined (and possibly tagged with metadata) for the items of media content. The processing system may further determine (or predefined metadata may identify) the typical audiences (e.g., kids, specific cultures, etc.) for the items of media content (e.g., through analysis of viewership or manual metadata).

The method 200 begins in step 202 and proceeds to step 204. In optional step 204 (illustrated in phantom), the processing system may deliver a first item of media content to a user endpoint device of a first user. Step 204 may be considered optional because the first item of media content may be delivered to the user endpoint device by a device other than the processing system. For instance, the processing system may be operated by a service provider who provides a third party service to adapt media content that may be provided by other parties (e.g., streaming media service providers). In other examples, however, the party providing the first item of media content may be the same as the party who adapts the presentation of the media content (e.g., the ability to adapt the presentation of the media may be an added feature of a streaming media service).

As discussed above, the first item of media content may comprise audio-visual media (e.g., a movie, a television show, a news or sports broadcast, a video on demand program, a video game, an immersive or augmented reality media, etc.), audio-only media (e.g., music, a podcast, an audio book, etc.), video-only media (e.g., a slideshow of still images or short videos, etc.), or another type of media content.

The user endpoint device may comprise a smart television, a television coupled to a DVR, STB, or high definition multimedia interface (HDMI) plugin, a smart phone, a smart watch, a personal media player (e.g., a personal music player), a tablet computer, a laptop computer, a desktop computer, an immersive display, or any other device that is capable of receiving the first item of media content and presenting the first item of media content for consumption by an audience.

In one example, delivering the first item of media content to the user endpoint device may comprise delivering the same first item of media content to a plurality of user endpoint devices. The plurality of user endpoint devices may be co-located. For instance, a plurality of users including the first user may be watching the same movie together in the same room, but on respective immersive displays (e.g., HMDs). In another example, the plurality of user endpoint devices may be geographically distributed. For instance, the plurality of users may be watching the same movie together, but in their own respective homes and on respective devices (some of which may be immersive displays and some of which may be other types of user endpoint devices). In another example, the plurality of users may be watching the same movie but at different times (e.g., where one user views either part of a movie or the movie in its entirety before another user, with no specific requirements for viewing order for users or movie parts). In this example, the first user may become a second user, and then consume secondary items of media content interchangeably.

In step 206, the processing system may detect the audience for the first item of media content (i.e., the individual to whom the first item of media content is being presented). The audience includes at least the first user, but may additionally include other users. In one example, detecting the audience may comprise detecting at least one of: a number of people in the audience, an average age of the audience (e.g., a numerical age or a more general age, such as “teenager”), an age range of the audience (e.g., a numerical range or a range of more general ages, such as “children to young adult”), relationships among members of the audience (e.g., friends, parents and children, etc.), locations of the members of the audience (e.g., everyone in one location versus distributed over a plurality of locations) and a number and type of devices on which the audience is playing the first item of media content (e.g., everyone watching together on one television versus everyone watching individually on respective HMDs).

In one example, detecting the audience may involve receiving a signal from the first user (or another member of the audience), where the signal explicitly provides information about the audience (e.g., the number of people in the audience, the average age of the audience, the age range of the audience, the relationships among the members of the audience, the locations of the members of the audience, the locations of the members of the audience, and/or the numbers and types of devices on which the audience is playing the first item of media content). In another example, the first user may log into an account (e.g., an account with a subscription service) in order to access presentation of the first item of media content, and the first user's membership in the audience (as well as other audience information which may be stored in a user profile for the first user, such as age, other potential audience members, relationships to other potential audience members, and the like) may be inferred from the first user's act of logging in. In another example, a social graph of the first user (which may be inferred from the first user's social media accounts, for instance), may be used to infer the relationships of other detected individuals to the first user.

In another example, sensors that are part of the user endpoint device, or that are co-located with the user endpoint device (e.g., as part of another user endpoint device, an IoT device, etc.), may provide data from which the processing system may detect information about the audience. For instance, sensors may provide images of the audience, from which the number and/or ages of the audience may be inferred. Image processing techniques, including facial recognition techniques, may also allow the processing system to identify one or more audience members in the images, which may allow for the retrieval of profiles associated with those audience members. Sensors may also provide audio of the audience, from which the number and/or ages of the audience may be inferred. Audio processing techniques, such as voice recognition, sentiment analysis, and the like, may also allow the processing system to identify one or more audience members by voice and/or to extract meaning from utterances made by one or more audience members, where the extracted meaning may be useful in detecting the audience (e.g., “Wait for Jim to get back from the kitchen,” “Will this be too scary for the kids?,” etc.).

In step 208, the processing system may monitor the first user's reactions to the first item of media content during the presentation of the first item of media content. In one example, the first user's reactions may be monitored by analyzing real time sensor data provided by the same sensors that may provide data for detecting the audience. For instance, imaging sensors in the user endpoint device or near (e.g., in the same room with) the user endpoint device may provide images or video of the first user. The processing system may analyze images of the first user's face to detect a facial expression, and may associate a specific mood with that facial expression. For instance, if the first user is laughing or smiling, the processing system may infer that the first user is amused; if the first user is frowning or crying, the processing system may infer that the first user is sad; if the first user is screaming or covering his eyes, the processing system may infer that the first user is scared; if the first user is talking to another audience member, looking at his phone, or closes his eyes for an extended period of time, the processing system may infer that the first user is distracted or bored; if the first user is jumping up and down in his seat or gesturing wildly, the processing system may infer that the first user is excited; and so on.

In another example, an audio sensor in the user endpoint device or near (e.g., in the same room with) the user endpoint device may provide audio of the first user. The processing system may analyze the audio for specific sounds that may indicate the first user's mood, or may perform sentiment analysis on utterances captured in the audio to make a more precise inference. For instance, if the first user is laughing, or clapping, or says “that was funny,” the processing system may infer that the first user is amused; if the first user is crying or says “that was so sad,” the processing system may infer that the first user is sad; if the first user is screaming or says “I can't look,” the processing system may infer that the first user is scared; if the first user is in a conversation with someone else, or yawns, or says “is this almost over?,” the processing system may infer that the first user is distracted or bored; and so on.

In another example, a biometric sensor in the user endpoint device or near (e.g., in the same room with) the user endpoint device may provide biometric measurements of the first user. The processing system may analyze the biometric measurements for specific values or occurrences that may indicate the first user's mood. For instance, if the first user's heart rate is a threshold amount above a baseline for the first user, or if the first user is sweating profusely, or if the first user's pupils are dilated, the processing system may infer that the first user is scared; if the first user's heart rate is within a threshold amount of a baseline for the first user, the processing system may infer that the first user is distracted or bored; and so on.

In another example, the first user's reactions made be inferred from the first user's social media activity. For instance, the first user may post content on social media while the first item of media content is being presented, and the content posted on social media may give some insight as to the first user's reactions to the first item of media content. For instance, the first user may post a comment indicating that he thought a particular scene of a movie was especially funny or was too violent for his kids to watch.

Other methods for inferring the first user's reactions based on sensor data are possible. For instance, many techniques for inferring user emotions are known in the art. In some examples, correlations between the first user's appearance, sound, and/or biometrics and reactions may be user-specific rather than based on general or average reactions. For instance, the first user may be afraid of clowns, even when the clowns are presented in a context that, to most other users, would not be considered explicitly scary. The processing system may learn these user specific correlations, or the first user may provide information about these user specific correlations (e.g., via a user profile).

In step 210, the processing system may determine whether to adjust the presentation of the first item of media content in response to the first user's reactions to the first item of media content. In one example, a user profile for the first user may specify when and/or how the first user wishes for adjustments to be made. For instance, the first user may scream during a scary scene, indicating that the first user is likely scared. However, the first user's profile may indicate that he enjoys scary movies; thus, the first user may not want the first item of media content to be adjusted just because he appears to be scared. However, in another case, the first user may cover his eyes during a scene in which there is a lot of blood, indicating that the first user is likely uncomfortable with the gore. The first user's profile may also indicate that the first user does not like gory content; thus, the first user may welcome an adjustment that lessens the gore in the first item of media content.

In another example, the determination as to whether to adjust the first item of media content may take into account the reactions of multiple audience members. For instance, if a plurality of users is watching a movie together on a single user endpoint device (e.g., a television), different users of the plurality of users may react in different ways to the same scenes or events in the movie. For instance, the first user may cover his eyes during a scary scene, while a second user may jump in her seat, and a third user may yell at the television. In this case, the processing system may mediate among the different reactions to find a middle ground, which may or may not result in a determination that an adjustment should be made.

In a further example, the processing system may ask for user confirmation before determining whether an adjustment to the first item of media content should be made. For instance, the processing system may present an interactive dialog on a screen of the user endpoint device, or on another user endpoint device in the vicinity of the user endpoint device (e.g., the first user's mobile phone or smart watch, which may be less intrusive than presenting the dialog on the screen of the user endpoint device on which the first item of media content is being presented) to ask whether the first user would prefer that the first item of media content be adjusted. In this way, the processing system may avoid making unwanted or unnecessary adjustments to the first item of media content. The first user may also send a signal to the processing system (e.g., by pressing a button on a remote control, a smart phone, or the like) requesting an adjustment, without being prompted by the processing system for confirmation.

If the processing system determines in step 210 that no adaptation should be made to the first item of media content, then the method 200 may return to step 208 and continue to monitor the first user's reactions. If, however, the processing system determines in step 210 that an adaptation should be made to the first item of media content, then the method 200 may proceed to step 212.

In step 212, the processing system may send an instruction to the user endpoint device instructing the user endpoint device to adapt the presentation of the first item of media content in response to the first user's reactions. The instruction may include an identification of the specific adaptation to be made, and may, in some cases, include additional media or data to be presented simultaneously with the first item of media content.

As discussed above, there are a variety of ways in which the presentation of the first item of media content may be adapted in response to the first user's reactions. One way is to adjust the length of the first item of media content, or at least the length of a portion of the first item of media content that is currently being presented. For instance, the current portion may be shortened (e.g., by skipping or speeding up playback of the current portion) if the first user's reactions indicate that the first user does not appear to be enjoying the current portion (e.g., is scared, sad, distracted, bored, etc.). Alternatively, the current portion may be lengthened (e.g., an extended version of the portion may be presented) if the first user appears to be enjoying the current portion (e.g., is happy, excited, amused, etc.).

In another example, a visual component of the first media item may be adapted. For instance, the processing system may blur or obscure a portion of a scene of a movie if the first user is observed to be covering his eyes or squirming in his seat (which may indicate fright, discomfort, or disgust).

In another example, an audio component of the first media item may be adapted. For instance, the processing system may lower the volume if the first user is observed covering his ears or may raise the volume if the first user is observed to repeatedly increase the volume manually (e.g., via a remote control). In another example, a portion of the audio component may be changed. For instance, if the first user is observed stating, “I don't like this song,” then the processing system may substitute a different song (potentially by an artist that the first user is known to like, based on the first user's profile) or may lower the volume of the song relative to other audio (e.g., character dialogue, sound effects, etc.). In another example, the processing system may add an audio component to a portion of the first item of media content. For instance, during a funny scene of a television show, a canned laugh track may be muted or canceled from the audio signal, and a recording of the first user's friend of family member laughing (which may be stored in conjunction with the first user's profile) may be played instead. In another example, an added audio component may comprise white noise to mitigate potentially distracting sounds such as ringing phones, other users talking, and the like.

In another example, the processing system may present information from an external source simultaneously with the first item of media content. The information from the external source may be presented on the same user endpoint device as the first item of media content or on a different user endpoint device (so as to be less disruptive). In one example, the information from the external source may comprise audio, video, text, or other content that is related in some way to the portion of the first item of media content that is currently being presented. For instance, if the currently scene is a movie that takes place at some historical site, and the first user says, “where is that?,” then the processing system may retrieve information about the historical site (e.g., from the Internet) and may display the information as a crawl, a pop up, or the like on the bottom of the user's television. Alternatively, if the user says, “I wonder why they picked this song,” when a particular song is played during the movie, the processing system may play (e.g., either as additional audio or displayed as text) a director's commentary track.

In another example, the adaptation to the presentation of the first item of media content may comprise a haptic feedback. For instance, if the first item of media content is a video game, the haptic feedback may comprise a rumble, a vibration, or some other form of tactile feedback that may be transmitted to the first user via, for example, a game controller. For instance, if the first user does not appear to be paying attention to the first item of media content (e.g., based on images of the first user looking away or talking with another person), the processing system may adjust the presentation of the first item of media content by adding a haptic feedback to try to regain the first user's attention.

In another example, the processing system may add a virtual component to the item of media content. For instance, if the first user is using an HMD that presents a film in a setting of a “virtual” theater, the processing system may add virtual audience members to the other seats in the virtual theater so that the first user does not feel so alone, which may make scary scenes of the film seem less scary. In one example, the virtual audience members may resemble the first user's friends and family members. In another example, the addition (or removal) of virtual audience members could be executed to mirror (or augment) the reaction of other users based on audience reactions. In a crowded “virtual” theater, one user may be more self-conscious or reserved in the immersion and less open to crying while surrounded by others. However, if the system detects additional users (not virtual audience members) who react more emotionally while watching the media content, the system may reduce the number of virtual audience members in select HMD displays to amplify that sympathetic reaction.

As discussed above, in some examples, the first user may be one of a plurality of users to whom the first item of media content is being presented simultaneously. For instance, the plurality of users may comprise a group of friends or family members who are watching a movie together. When all users of the plurality of users are watching on their own respective user endpoint devices (e.g., respective HMDs if co-located, or even respective televisions or computer displays, if the users are not co-located), the adjustment to the presentation of the first item of media content may only be made for the first user. In this case, other users may experience different adjustments to the presentation of the same portion of the first item of media content, or no adjustments at all. Thus, at least one user of the plurality of users may not experience the adjustment that the first user experiences.

However, if the plurality of users is co-located and the first item of media content is being presented to all of the users on the same user endpoint device, then the adjustment may be made in a way that attempts to mediate between the different (and potentially conflicting) reactions of the plurality of users. In this case, the adjustment may be the most conservative adjustment that could be made out of a plurality of identified adjustments. For instance, if the first user appears to be disgusted by a gory scene of a movie, a second user appears to be mildly uncomfortable, and a third user appears to be completely unbothered, then the adjustment may attempt to minimize the gore as much as possible (e.g., by blurring the images, skipping the scene, or the like). In another example, the adjustment may be made in a manner that attempts to find a compromise or middle ground between all of the reactions of between the most extreme reactions (e.g., showing an abbreviated version of the scene in the above example of the three users). In another example, the adjustment may be made to satisfy the maximal number of users (e.g., if the first and second user both appear disgusted and the third user appears unbothered, blur or skip the scene). In yet another example, the users may agree on a specific user whose reactions will control how the adjustments are made (e.g., always adjust for the second user's reactions when multiple reactions conflict).

In another example where the plurality of users is co-located, and the adjustment comprises an adjustment to the audio component of the first item of media content, different adjustments may be presented to different users by manipulating the speaker output. For instance, based on sensor data such as images and/or audio of the users, the processing system may be able to estimate where each user is sitting in relation to a surround sound speaker system (e.g., an array of speakers arranged to provide directional output). If the first user appears to feel that the volume is too high (e.g., images show the first user holding his hands over his ears), but the rest of the users do not seem to be bothered by the volume, then the output of the speaker system may be adjusted so that the volume is lowered only for the first user. For instance, the volume of the audio output by one specific speaker that is located closest to the first user may be lowered. Alternatively, beamforming techniques may be used to vary the volume of the speaker output heard by different users, without the need for a multi-speaker array.

In optional step 214, the processing system may collect user feedback with respect to the adjustment. In one example, the user feedback may comprise explicit feedback indicating whether or not the first user was satisfied with the adjustment. For instance, the first user may provide a signal via an interactive dialog to indicate whether or not the adjustment improved his enjoyment of the first item of media content. In another example, the sensors may detect a predefined gesture or statement that indicates that the first user is satisfied (e.g., the first user may say “that's better,” or may give a thumbs up).

Alternatively, the user feedback may comprise implicit feedback that may be inferred in a similar way to the inference of the first user's reactions. For instance, if the first user was inferred to be scared because the first user's heart rate was elevated, and the first user's heart rate lowers after the adjustment is made, then the processing system may infer that the adjustment successfully lessened the first user's fright.

The user feedback may be used by the processing system to inform the manner in which future adjustments to the presentation of the first item of media content (and other items of media content which may be presented to the user in the future) may be made for the first user. For instance, if the adjustment made in step 212 is deemed to have been ineffective, or if the first user indicates dissatisfaction with the adjustment, then the processing system may make a different adjustment (or no adjustment at all) the next time the user reaction that motivated the adjustment is observed. Alternatively, if the adjustment made in step 212 is deemed to have been effective, or if the first user indicates satisfaction with the adjustment, then the processing system may make the same or a similar adjustment the next time the user reaction that motivated the adjustment is observed.

Thus, after collecting the user feedback, the method 200 may return to step 208 and continue to monitor the first user's reactions and make adjustments to the presentation of the first item of media content as needed. The method 200 may therefore iterate through at least steps 208-214 for as long as the first item of media content is being presented, or until the first user sends some signal indicating that adjustments to the presentation of the first item of media content are unwanted or unneeded.

The method 200 therefore allows the presentation of media content to be dynamically adapted, in real time, in response to a user's reactions to the media content, which ideally will make for a more enjoyable and engaging experience for the user. The information regarding user reactions and adjustments can also be provided to content creators to help the content creators tune their content to user preferences (e.g., most users prefer the laugh track to be removed). In further examples, information regarding user reactions and adjustments may also be used to identify potential advertising slots in the content (e.g., add a commercial break during a scene where average user engagement is high to increase the chances of users watching and paying attention to the commercial).

In further examples, the method 200 may be used to adapt the presentation of items of media content for different cultures or international markets. For instance, the audio track of a film, which may have been recorded in a first language, could be replaced with an audio track in a second language. Moreover, the presentation of content that may be considered inoffensive or clear to one culture, but offensive or confusing to another (e.g., jokes that may not translate from one language to another), may be adapted or removed according to cultural preferences.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for dynamically adapting media content to specific users in real time, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner fora particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for dynamically adapting media content to specific users in real time (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for dynamically adapting media content to specific users in real time (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
detecting, by a processing system including at least one processor, an audience for a first item of media content being delivered to a user endpoint device, wherein the audience includes at least a first user;
monitoring, by the processing system, a reaction of the first user to the first item of media content during a presentation of the first item of media content on the user endpoint device;
determining, by the processing system, an adaptation to be made to the presentation of the first item of media content in response to the reaction of the first user, wherein a nature of the adaptation varies depending upon a nature of the reaction; and
sending, by the processing system, an instruction to at least one device to make the adaptation to the presentation in response to the reaction of the first user.

2. The method of claim 1, wherein the detecting comprises:
receiving, by the processing system, data collected by at least one sensor in a vicinity of the user endpoint device; and
analyzing, by the processing system, the data to detect the audience.

3. The method of claim 2, wherein the at least one sensor is integrated in the user endpoint device.

4. The method of claim 2, wherein the at least one sensor is integrated in a device other than the user endpoint device.

5. The method of claim 2, wherein the data comprises at least one of: audio of the audience or images of the audience.

6. The method of claim 1, wherein the detecting the audience comprises detecting at least one of: an identity of at least one individual in the audience, a number of individuals in the audience, an average age of individuals in the audience, an age range of individuals in the audience, a relationship between at least two individuals in the audience, a location of at least one individual in the audience, and a number of devices on which the audience is playing the first item of media content, or a type of at least one device in which the audience is playing the first item of media content.

7. The method of claim 1, wherein the adaptation comprises shortening a portion of the first item of media content.

8. The method of claim 1, wherein the adaptation comprises lengthening a portion of the first item of media content.

9. The method of claim 1, wherein the adaptation comprises at least one of: blurring a portion of an image of the first item of media content or blocking the portion of the image of the first item of media content.

10. The method of claim 1, wherein the adaptation comprises adjusting a volume of an audio component of a portion of the first item of media content.

11. The method of claim 1, wherein the adaptation comprises replacing an audio component of a portion of the first item of media content.

12. The method of claim 1, wherein the adaptation comprises adding an audio component to a portion of the first item of media content.

13. The method of claim 1, wherein the adaptation comprises presenting information from an external data source simultaneously with presenting the first item of media content.

14. The method of claim 1, wherein the adaptation comprises a haptic feedback.

15. The method of claim 1, wherein the adaptation comprises a presentation of a virtual component simultaneously with the first item of media content.

16. The method of claim 1, wherein the audience comprises a plurality of users including the first user, and all users of the plurality of users are experiencing the first item of media content together on the user endpoint device, and wherein the adaptation comprises a single adaptation that mediates between a plurality of different reactions of the plurality of users to the first item of media content.

17. The method of claim 16, wherein the adaptation comprises a compromise between a first adaptation to respond to a first reaction of the plurality of different reactions and a second adaptation to respond to a second reaction of the plurality of different reactions, and wherein the first reaction and the second reaction comprise opposite extremes of the plurality of different reactions.

18. The method of claim 1, further comprising:
collecting, by the processing system, feedback with respect to a reaction of the first user to the adaptation.

19. A non-transitory computer-readable medium storing instructions which, when executed by a processing system including at least one processor, cause the processing system to perform operations, the operations comprising:
detecting an audience for a first item of media content being delivered to a user endpoint device, wherein the audience includes at least a first user;
monitoring a reaction of the first user to the first item of media content during a presentation of the first item of media content on the user endpoint device;
determining an adaptation to be made to the presentation of the first item of media content in response to the reaction of the first user, wherein a nature of the adaptation varies depending upon a nature of the reaction; and
sending an instruction to at least one device to make the adaptation to the presentation in response to the reaction of the first user.

20. A device comprising:
a processing system including at least one processor; and
a non-transitory computer-readable medium storing instructions which, when executed by the processing system, cause the processing system to perform operations, the operations comprising:
detecting an audience for a first item of media content being delivered to a user endpoint device, wherein the audience includes at least a first user;
monitoring a reaction of the first user to the first item of media content during a presentation of the first item of media content on the user endpoint device;
determining an adaptation to be made to the presentation of the first item of media content in response to the reaction of the first user, wherein a nature of the adaptation varies depending upon a nature of the reaction; and
sending an instruction to at least one device to make the adaptation to the presentation in response to the reaction of the first user.
